(19) United States
(12) Patent Application Publication
(10) Pub. No.: US 2007/0277747 A1
(43) Pub. Date: Dec. 6, 2007

(54) Pet toy having intersecting tires

(75) Inventor: James W. Gick, Laguna Niguel, CA (US)

Correspondence Address: CROCKETT & CROCKETT, 24012 CALLE DE LA PLATA, SUITE 400, LAGUNA HILLS, CA, 92653, US

(73) Assignee: Pet Qwerks, Inc.

(21) Appl. No.: 11/827,265

(22) Filed: Jul. 10, 2007

Related U.S. Application Data
(63) Continuation of application No. 10/942,551, filed on Sep. 15, 2004, now abandoned.

(51) Int. Cl. A01K 29/00

(52) U.S. Cl. 119/707

(57) ABSTRACT

A pet toy comprising two intersecting tires. The center of each tire occupies substantially the same point and the axis of one tire is perpendicular to the axis of the other tire.

### RELATED APPLICATIONS

This application is a continuation of U.S. Utility application Ser. No. 10/942,551 filed Sep. 15, 2004.

### FIELD OF THE INVENTIONS

The inventions described below relate the field of pet toys.

### BACKGROUND OF THE INVENTIONS

New and improved pet toys are constantly sought in order to better sell pet toys to pet owners. New pet toys should be durable, inexpensive and designed to stimulate a dog, cat or other animal to play with the toy. A well-known type of pet toy is a rubber or plastic ball, such as that shown in Silverglate, Toy Ball Apparatus, U.S. Pat. No. 6,729,984 (May 4, 2004). (Silverglate shows a ball comprising a mesh having a plurality of loop structures forming a spherical surface.)

### SUMMARY

The methods and devices shown below provide for a pet toy in the form of two intersecting-rubber tires. The axes of the tires are perpendicular to each other and the center of each tire is also the center of the overall toy. A ball may be disposed in the center of the toy, inside the inner diameter of the tires.

### BRIEF DESCRIPTION OF THE DRAWINGS

FIG. 1 shows a pet toy comprising two intersecting tires.

FIG. 2 shows a pet toy comprising two intersecting tires as seen from the top of the toy.

FIG. 3 shows a pet toy comprising three intersecting tires as seen from the top of the toy.

FIG. 4 shows a pet toy comprising two intersecting tires as seen from the top of the toy with a ball disposed within the inner diameters of the tires.

FIG. 5 shows a pet toy comprising two intersecting tires as seen from the top of the toy with a ball sized and dimensioned to bounce within the toy as the toy rolls along a surface.

### DETAILED DESCRIPTION OF THE INVENTIONS

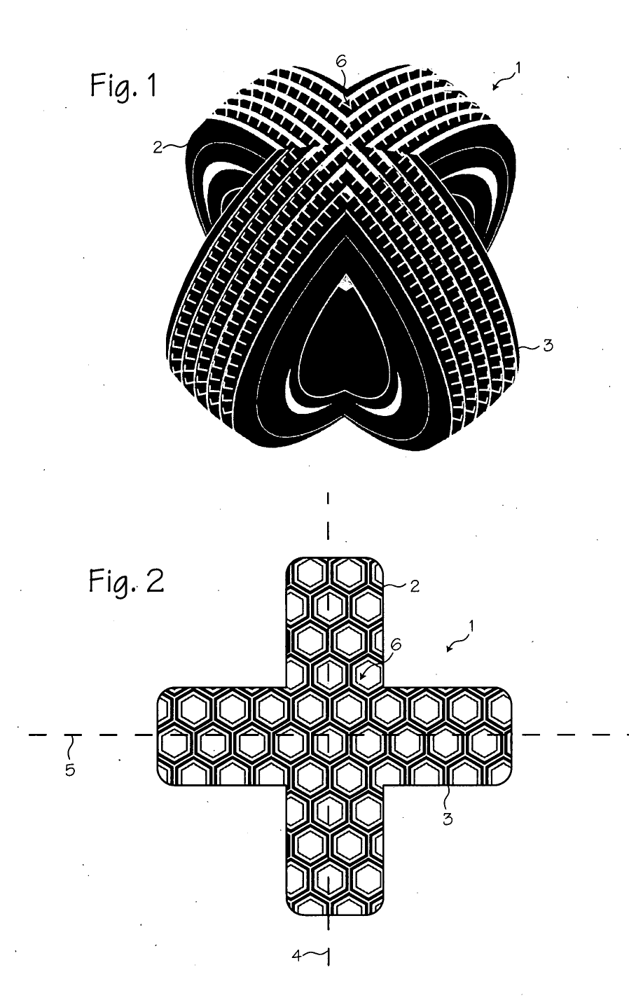

FIGS. 1 and 2 show a pet toy 1 comprising two tires, a first tire 2 and a second tire 3, that intersect such that the center of each tire occupies substantially the same point and is the about same as the center of the toy. The tires are further disposed such that the axis 4 of the first tire is substantially perpendicular to the axis 5 of the second tire.

Although the tires may be made from a variety of materials and may comprise hoops rather than tires, preferably the tires are made from a durable rubber or a material with similar properties. Rubber tires roll and bounce well, may be provided with a variety of tread patterns 6 and are tough enough to withstand a dog playing with the toy.

The toy shown in FIGS. 1 and 2 enjoys several advantages over a single tire and over traditional balls. The toy shown in FIGS. 1 and 2 rolls in a more stable way than a single tire; in other words, the toy can roll farther along a straight line and can roll more easily than a single tire. The toy also produces an enticing bounce when the rolling toy slows, unlike a ball or a single tire. The toy is easy to grasp, making it easier to retrieve the toy or to grip the toy while a dog grips the other end of a tire, unlike a ball.

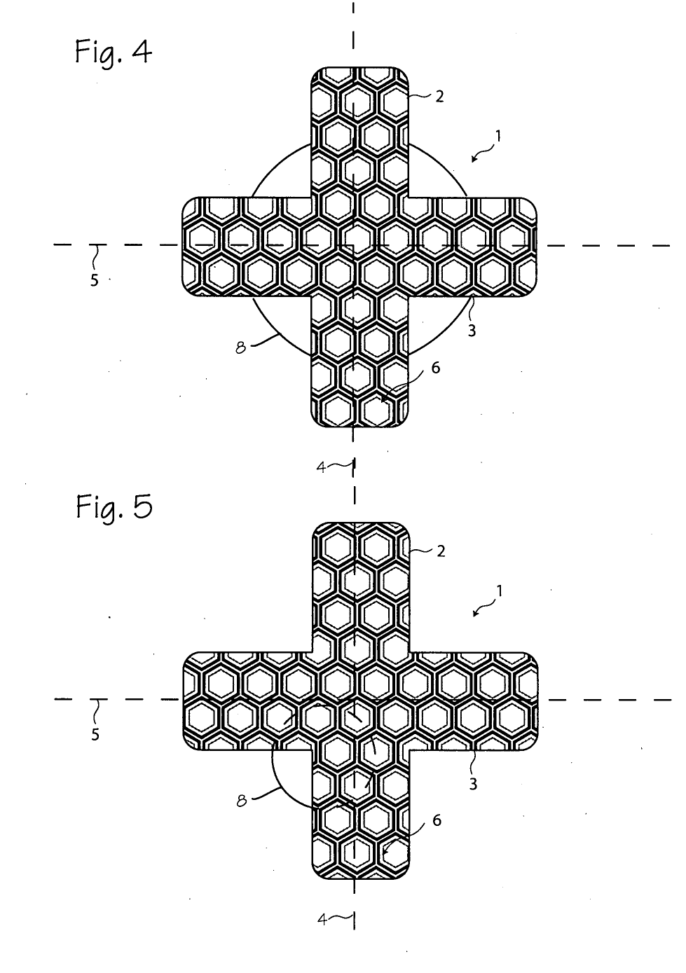

The dual-tire toy may be provided with additional features. For example, the toy may be provided with one or more tread patterns to change how the toy rolls or to help the toy to roll along different kinds of surfaces. Each tire may be provided with internal belts (much like automobile radial tires) in order to increase the durability of the tires. A second ball 8, as shown in FIG. 4, or other toy may be provided in the center of the toy (within the inner diameter of each tire) to enhance the appeal of the toy. The second ball 8 may be sized and dimensioned to bounce within the toy as the toy rolls along a surface as shown in FIG. 5. In addition, the toy and the second ball may be painted a variety of attractive colors or marked in a variety of ways. Thus, the toy may be marked and marketed as a children's toy.

In addition, the tire or the second ball may be provided with electronics, speakers and lights that light-up, flash or make noises. An example of balls that may be placed within the toy shown in FIGS. 1 and 2 may be found in my application Ser. Nos. 10/877,917 and 10/877,877. Similar sound or light producing technology may be incorporated within or on the surface of the toy shown in FIGS. 1 and 2.

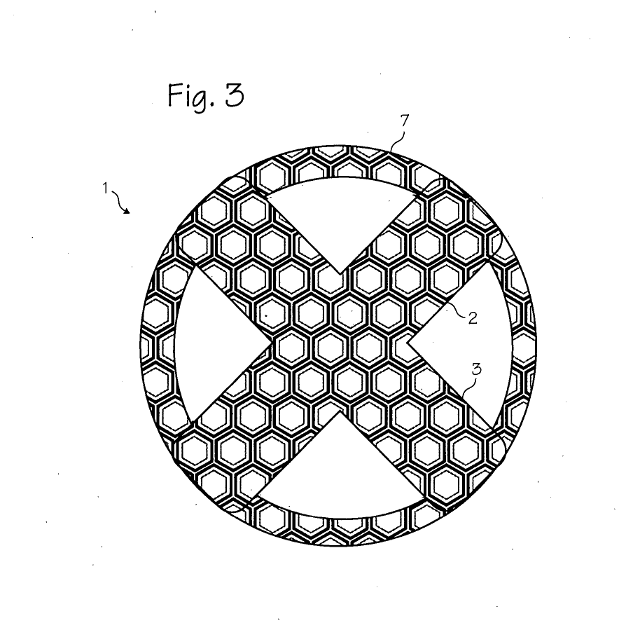

The toy may comprise more than two intersecting tires. As shown in FIG. 3, a first tire 2, a second tire 3 and a third tire 7 may intersect ninety degree angles to form the toy.

The toy may comprise more than three intersecting tires whose axes are disposed at various angles relative to each other. Likewise, the angle between the axes of the two tires shown in FIGS. 1 through 3 need not be perpendicular and may vary between a few degrees and 90 degrees. Whatever the configuration of tires, the center of each tire preferably occupies the same point as all of the other tires. However, the centers of each tire may be displaced slightly from the center of the toy in order to change how the ball rolls along a surface.

The toy may be manufactured by any known manufacturing technique. Preferably, the tires are molded together as a unit so that the tires appear to intersect each other, even though the toy is constructed as a single unit. The tires may also be attached to each other by cutting the tires into appropriate shapes and then adhering or melting them together. However the toy is manufactured or constructed, the tires may be thought of as being connected together.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A pet toy comprising:
a first tire with a tread pattern having a center and an axis;
a second tire with a tread pattern connected to the first tire, said second tire having a center and an axis;
wherein the axis of the first tire is substantially perpendicular to the axis of the second tire and wherein the center of the first tire and the center of the second tire occupy substantially the same point.

2. The pet toy of claim 1 further comprising a ball disposed within an inner diameter of the first tire and the inner diameter of the second tire.

3. The pet toy of claim 1 wherein the first tire is a rubber tire and the second tire is a rubber tire.

4.-6. (canceled)

7. The pet toy of claim 1 further comprising a ball disposed within an inner diameter of the first tire and within an inner diameter of the second tire, wherein said ball is sized and dimension and disposed such that the ball can bounce within the inner diameter of the first tire and the inner diameter of the second tire.
